(19) United States
(12) Patent Application Publication
(10) Pub. No.: US 2021/0086004 A1
(43) Pub. Date: Mar. 25, 2021

(54) FLAME RESISTANT, BREATHABLE PROTECTIVE GARMENTS FOR FIRE FIGHTERS AND FIRST RESPONDERS

(71) Applicant: INVISTA NORTH AMERICA S.A.R.L., WILMINGTON, DE (US)

(72) Inventor: Chuanpu GUO, Marietta, GA (US)

(73) Assignee: INVISTA NORTH AMERICA S.A.R.L., WILMINGTON, DE (US)

(21) Appl. No.: 16/634,164

(22) PCT Filed: Jul. 25, 2018
(86) PCT No.: PCT/US2018/043593

§ 371 Date: Jan. 27, 2020

Related U.S. Application Data
(60) Provisional application No. 62/537,494, filed on Jul. 27, 2017.

(51) Int. Cl. A62B 17/00; B32B 5/02; B32B 5/18; B32B 5/24; B32B 27/12; B32B 27/32; B32B 27/40

(52) U.S. Cl. CPC A62B 17/003; B32B 2437/00; B32B 5/024; B32B 5/026; B32B 5/18; B32B 5/245; B32B 27/12; B32B 27/322; B32B 27/40; B32B 2255/10; B32B 2255/26; B32B 2262/0246; B32B 2262/0269; B32B 2307/3065; B32B 2307/724; B32B 2307/7265; B32B 5/022

(57) ABSTRACT

A two-layer flame resistant garment is disclosed having an outer layer and an inner layer, wherein the outer layer has a flame resistant shell fabric laminated to a waterproof breathable layer. Also disclosed is a flame resistant garment having one layer fabric construction, wherein the one layer has a flame resistant outer shell, a waterproof breathable membrane, and a thermal management polymer coating.

### FIELD OF THE INVENTION

The present invention relates to flame resistant, waterproof, breathable protective garments for structural fire fighting and technical rescue applications. Unlike the traditional turnout gears that have three-layer construction, the disclosed protective garments have two-layer, and one-layer constructions. The invented protective garments not only provide superior thermal and flame resistant protection but also offer cooling and moisture management end use functionality.

### BACKGROUND OF THE INVENTION

Flame resistant protective garments are worn by fire fighters or emergency responders to reduce potential body injuries when exposed to thermal and flame hazards during routine and emergency job duties. Currently, the typical firefighter protective garments comprise three layers: an outer shell layer, a moisture barrier layer, and a thermal barrier layer.

An outer shell fabric layer is used to resist heat and direct flame and prevent physical damage to the internal layers in the form of, for example, cuts, punctures, tears, slashes, and abrasions. The outer shell fabric is typically made with flame resistant fibers such as para-aramid fibers (Kevlar® and Twaron®), meta-aramid fibers (Nomex®), polybenzimidazole fibers (PBI), polybenzoxazole fibers (PBO), Basofil® fibers, and Tecgen® fibers. Usually, at least two different high performance fibers are blended together for use to achieve optimum thermal and physical performance.

A moisture barrier layer is employed to prevent water, and liquids, from penetrating into the thermal layers while allowing transmission of moisture vapor, to reduce the accumulated heat stress to the wearer. The most commonly used moisture barriers are composed of a thin and compactly woven aramid fabric laminated or bonded with waterproof, breathable membranes, such as expanded polytetrafluoroethylene (ePTFB) membranes such as Gore-Tex® or Crosstech® materials manufactured by W.L. Gore & Associates, Inc.

A thermal barrier layer consists of spun-laced or needle-punched nonwoven substrates laminated or quilted with a thin woven aramid face fabric. The nonwoven liners are usually composed of flame and thermal resistance fibers such as para-aramid fibers (Kevlar® and Twaron®), meta-aramid fibers (Nomex®), polybenzimidazole fibers (PBI), and polybenzoxazole fibers (PBO), and Basofil® fibers or their blends. The desirable thermal barriers have high porosity to entrain air, and this in turn will form an effective barrier against heat transfer to the subject's body.

U.S. Patent Application Publication no. 2008 0209611 ('611 publication) discloses a protective garment comprising an outer shell and liners that can meet various application requirements. More particularly, the invention is a garment outer shell and liners including a garment outer shell and a first liner having first protective properties and a second liner having second protective properties differing from the first protective properties. Each liner is adapted to fit to or remove from the outer shell.

PCT Publication no. 2015 021310 discloses a modular firefighting ensemble including a jacket and a vest to be worn together. The jacket without the vest can meet the NFPA 1951 standards for technical rescue, and when worn in connection with the vest can meet the NFPA 1971 standards for structural firefighting.

A protective garment for fire fighters, known as “turnout gear” in the trade, is usually produced with three layer constructions comprising outer shell, moisture barrier, and thermal barrier layers. This turnout gear is usually heavy, bulky, and hot for a fire fighter or emergency responder. Thus, there is a continued need to provide fire fighters or emergency responders with protective garments that offer sufficient protection but is not heavy in weight, complex in construction, and uncomfortable to wear. The disclosed modular turnout gear is still composed three layer constructions including outer shell, moisture barrier, and thermal barrier. The '611 publication claims a protective garment comprising outer shell and liner, but actually, the disclosed liner consists of moisture barrier and thermal barrier components. Although the flexibility of a modular turnout gear is improved, the protective garment system is still heavy, bulky, and hot for firefighters or emergency responders.

### SUMMARY OF THE INVENTION

In general, the present invention relates to a flame resistant, waterproof, and breathable protective garment for structural fire fighting and technical rescue applications. Unlike the traditional turnout gears that have three-layer construction, the invented protective garments only have a two-layer construction. The outer shell fabric is laminated together with the waterproof, breathable membrane. The separate thermal barrier comprises a nonwoven liner batted with a face cloth, optionally coated with sulfonated pentablock copolymer inside. Sulfonated pentablock copolymer coating offers smart cooling and moisture management functions. The invented protective garments may only have a one-layer construction for technical rescue applications, where the outer shell fabric is laminated together with the waterproof, breathable membrane and optionally coated by sulfonated pentablock copolymer in mesh pattern on the surface of membranes without the separate thermal liners. The sulfonated pentablock coating not only offers the smart cooling and moisture management functions but also improves wearing durability of membranes. The invented two-layer or one-layer garments are light in weight, comfortable for wearing, and cost effective for end users. The invented protective garments offer superior thermal and flame resistant protection, comply with the protection performance requirements, and do not have the deficiency of the prior art.

### BRIEF DESCRIPTION OF THE DRAWINGS

FIG. 1 illustrates the inventive protective garments disclosed herein having two layer construction.

FIG. 2 illustrates the inventive protective garments disclosed herein having one layer construction.

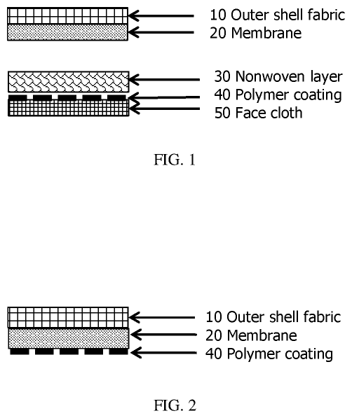

### DETAILED DESCRIPTION OF THE INVENTION

The present invention relates to a flame resistant, waterproof, breathable protective garments for structural fire fighting and technical rescue applications. Unlike the traditional turnout gears that have three-layer construction, the protective garments of the present disclosure may consist of only a two-layer construction. An outer shell fabric is laminated together with the waterproof, breathable membrane. Internal sewing seams on the laminated outer layer are sealed by a flame resistant, waterproof adhesive tape to prevent external water, liquids, and body fluids from penetrating into the thermal layer through sewing seams. A separate thermal barrier comprises nonwoven layers batted with a face cloth, with or without a sulfonated copolymer coating inside. The sulfonated pentablock copolymer coating significantly improves wearing durability of membranes, and offers advanced cooling and moisture management functionality.

Protective garments of the present disclosure may consist of only a one-layer construction, such as for technical rescue applications, where the outer shell fabric is laminated together with the waterproof, breathable membrane, with or without coating by sulfonated copolymer in a mesh pattern on the surface of membranes, and without a separate thermal barrier. Internal sewing seams on the laminated outer layer are sealed by a flame resistant, waterproof adhesive tape to prevent external water, liquids, and body fluids from penetrating into the inside through sewing seams. The sulfonated copolymer coating not only offers advanced cooling and moisture management functions, but also improves wear durability of the adjacent membrane materials.

In general, nonwoven materials can offer better thermal protection performance (TPP) and total heat loss (THL) performance than woven fabrics at the same weight and lower cost. Removal of a thin aramid fabric provides an opportunity to improve TPP and THL performance of a protective garment through adding additional nonwoven substrates lower in weight in the thermal barrier than the weight of removed aramid fabric in the moisture barrier.

The two-layer or one-layer gears of the present disclosure are light in weight due to the removal of the aramid reinforced fabric, comfortable for wearing due to improvement in the THL performance, and cost-effective for end users due to use of more nonwoven materials, less woven fabric, and simpler construction. New protective garments disclosed herein not only provide superior thermal and flame resistant protection, but also offer the additional smart cooling and moisture management functions.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer physics, fabrics, textiles, and the like, which are within the skill of the art. Such techniques are fully explained in the literature.

Flame resistant garments are typically made from fabrics comprising flame resistant fibers. In some embodiments, the flame resistant fibers include para-aramid fibers, meta-aramid fibers, polybenzimidazole fibers, polybenzoxazole fibers, melamine fibers, and oxidized polyacrylonitrile fibers. The fabrics may comprise a blend of different inherently flame resistant fibers. Typically, at least two different inherently flame resistant fibers are used to construct the fabrics.

Examples of para-aramid fibers include Kevlar® made by DuPont, Technora® and Twaron® by Teijin. Meta-aramid fibers include Nomex® and NOMEX® IIIA by DuPont, Conex® by Teijin. Polybenzoxazole fibers (PBO) include Zylon® by Toyobo. Polybenzimidazole fibers include PBI by PBI Performance. Melamine fibers include Basofil® by Basofil Fiber LLC. The oxidized polyacrylonitrile fibers include the oxidized polymer selected from the group comprising acrylonitrile based homopolymers, acrylonitrile based copolymers, acrylonitrile based terpolymers, and combinations thereof.

The fiber blends as disclosed herein can be used to form woven, knit, and nonwoven fabrics. Woven constructions can include plain, basket, twill, satin or sateen weave, as well as a more durable ripstop weave. The fabrics in some embodiments can be formed with the yarns that can be produced by the various type spinning technologies such as ring spinning, OE, air jet, Vortex, core spun, and others. The fabrics in some embodiments can be dyed by commercially available dye methods.

The flame resistant fabrics disclosed herein are laminated together with a waterproof, breathable membrane to form an outer flame resistant layer. In some embodiments, waterproof and breathable membranes include expanded PTFE (ePTFE) membranes. These microporous or hydrophobic membranes are designed to prevent water penetration, and allow water vapor transport. Examples of waterproof and breathable membranes include the breathable ePTFE membranes from Stedfast Inc., and Gore-Tex® materials manufactured by W.L. Gore & Associates, Inc.

In one non-limiting embodiment, sulfonated copolymers are used as continuous coatings, to coat the internally-facing surface of the face cloth of the thermal layer of two-layer protective garments.

In another non-limiting embodiment, sulfonated copolymers are used as discontinuous coatings, to coat the internally-facing surface of the face cloth of the thermal layer of two-layer protective garments. Examples of suitable discontinuous coating patterns are mesh, hemispherical dot, zig-zag, random, and cubic.

In another non-limiting embodiment, sulfonated copolymers are used in mesh patterns on the underside of outer shell fabric laminated with a flame resistant, waterproof, breathable membrane of one-layer protective garments for technical rescue applications.

The sulfonated copolymer coating technology provides two performance attributes to the protective garment system. First, the coating offers the smart cooling and moisture management functions to protective garment system. Second, the coating significantly improves wearing durability of the laminated membranes in the one-layer protective garments for technical rescue applications.

Examples of sulfonated copolymers suitable for use according to the present disclosure include the sulfonated pentablock copolymers having the brand name of Nexar™, by Kraton Inc. It is believed the technology utilizes the body's natural sweating process to fuel an active cooling process. Thus, as moisture is absorbed from the skin surface, the Nexar™ polymer swells and binds with the moisture, which, when released to the environment through evaporation, provides a cooling effect. Examples of Nexar™ polymer products include MD9100, MD9110, MD9150, MD9151, MD9200, MD9204, MD9205, MD9207, MD9210, and MD9214. Such sulfonated copolymer products are described in U.S. Pat. No. 7,737,224, incorporated by reference herein in its entirety. The sulfonated copolymers have at least two polymer end blocks that are resistant to sulfonation and at least one polymer interior block that is susceptible to sulfonation.

It is believed the fabrics used in the structural fire fighting in some embodiments provide superior flame and thermal protection performance in accordance with the industrial standard test methods. The fabrics of some embodiments have a char length less than 4 inches (10 cm) in a vertical flammability test according to the ASTM D6413: Standard Test Method for Flame Resistance of Textiles per the NFPA 1971 (National Fire Protection Association) Standard on Protective Ensembles for Structural Fire Fighting and Proximity Fire Fighting (Section 7.1.3). The fabrics of some embodiments have the thermal protective performance (TPP) rating greater than 35.0 cal/cm² per the NFPA 1971 standard (Section 7.1.1). The fabrics of some embodiments have the thermal shrinkage less than 10 percentages per the NFPA 1971 standard (Section 7.1.4). The fabrics of some embodiments have the total heat loss (THL) more than 205 w/m² per the NFPA 1971 standard (Section 7.2.2), which would allow excess body heat to escape and reduce heat stress.

The two-layer fabrics used in structural fire fighting in some embodiments offer good mechanical protection performance in accordance with the industrial standard test methods. The fabrics of some embodiments have breaking strength more than 140 lbs (623 N), tear strength more than 22 lbs (98 N), and abrasion resistance more than 50 lbs (222 N) per the NFPA 1971 standard (Section 7.1 and 7.2).

The one-layer fabrics used in technical rescue in some embodiments provide superior flame and thermal protection performance in accordance with the industrial standard test methods. The fabrics of some embodiments have a char length less than 4 inches (10 cm) in a vertical flammability test according to the ASTM D6413: Standard Test Method for Flame Resistance of Textiles per the NFPA 1951 (National Fire Protection Association) Standard on Protective Ensembles for Technical Rescue Incidents (Section 7.2.1.7). The fabrics of some embodiments have the thermal protective performance (TPP) rating greater than 10.0 cal/cm² per the NFPA 1951 standard (Section 7.2.1.12). The fabrics of some embodiments have the thermal shrinkage less than 10 percent per the NFPA 1951 standard (Section 7.2.1.8). The fabrics of some embodiments have the total heat loss more than 450 w/m² per the NFPA 1951 standard (Section 7.2.1.1), which would allow excess body heat to escape and reduce heat stress.

The fabrics used in technical rescue in some embodiments offer good mechanical protection performance for technical rescue applications in accordance with the industrial standard test methods. The fabrics of some embodiments have breaking strength more than 90 lbs (400 N), tear strength more than 6.75 lbs (30 N), and abrasion resistance more than 50 lbs (222 N) per the NFPA 1951 (Section 7.2).

The fabrics used in both structural fire fighting and technical rescue in some embodiments offer good water and liquid resistance performance in accordance with the industrial standard test methods (NFPA 1971 Section 7.1 and NFPA 1951 Section 7.2). The fabrics in some embodiments passes the requirements in liquid penetration resistance test in accordance with ASTM F903, Standard Test Method for Resistance of Protective Clothing Materials to Penetration by Liquid, exposure procedure C.

The following section provides further illustration of the garments of this disclosure. These working examples are illustrative only and are not intended to limit the scope of the invention in any way.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### EXAMPLES

### Examples 1 and 2

Table 1 gives characteristics describing preferred embodiments for structural fire fighting applications. The garment described by Example 1 is a traditional three layer composite system, which was used as a baseline for comparison with inventive Example 2. The outer shell of Example 1 was a ripstop woven fabric, at a weight of 7.2 oz/yd² (241 g/m²). The outer shell fabric comprised a blend of 60 wt % Kevlar® fibers/40 wt % Nomex® fibers. The moisture barrier of Example 1 was 100% Nomex® MA plain fabric, laminated with a breathable ePTFE membrane. The weight of the laminated fabric that used as a moisture barrier was 5.0 oz/yd² (167 g/m²). The thermal liner of Example 1 was composed of two layers of flat Kevlar®/Nomex® spun lace nonwoven fabrics batted with facecloth comprising Kevlar®, FR rayon, and nylon fibers. The weight of the thermal liner was 7.8 oz/yd² (261 g/m²). Unlike the traditional three layer composite system, the garment of Example 2 only comprises two layers. The same outer shell was laminated together with the waterproof, breathable membrane as one layer that plays a role as both outer shell, and moisture barrier. The thermal layer used in Example 2 is the same as that used in Example 1.

TABLE 1
Summary of garment characteristics for Example 1 and Example 2.

| Composite | Example 1 | | Example 2 |
|---|---|---|---|
| Layer Number | 3 | | 2 |
| Outer Shell | | Outer Shell + | |
| | | Moisture | |
| | | Barrier | |
| Fabric Weight | 7.2 | Fabric Weight | 7.2 |
| (oz/yd²) | | (oz/yd²) | |
| Fiber | 60% Kevlar ®/ | Fiber | 60% Kevlar ®/ |
| composition | 40% Nomex ® | composition | 40% Nomex ® |
| (%) | | (%) | |
| Fabric Style | Ripstop Weave | Fabric Style | Ripstop Weave |
| Moisture | | Membrane | Breathable |
| Barrier | | | ePTFE |
| | | | Membrane |
| Fabric Weight | 5.0 | | |
| (oz/yd²) | | | |
| Fiber | 100% | | |
| composition | Nomex ® | | |
| (%) | IIIA | | |
| Membrane | Breathable | | |
| | ePTFE | | |
| | Membrane | | |
| Thermal Liner | | Thermal Liner | |
| Weight (oz/yd²) | 7.8 | Weight (oz/yd²) | 7.8 |
| Facecloths | Kevlar ®, FR | Facecloths | Kevlar ®, FR |
| | Rayon, Nylon | | Rayon, Nylon |
| Batting | | Batting | |
| Fiber | Kevlar ®/ | Fiber | Kevlar ®/ |
| composition | Nomex ® | composition | Nomex ® |
| Construction | Two layers flat | Construction | Two layers flat |
| | spun lace | | spun lace |

Table 2 lists test results on composite samples of some preferred embodiments for structural fire fighting applications. Both composite samples showed the good performance in thermal protection such as TPP and vertical flammability. However, the garment described by inventive Example 2 shows a higher total heat loss (THL) value at lighter weight than does Example 1. Clearly, this indicated that the composite garment of Example 2 would be more comfortable for wearing by a fire fighter.

TABLE 2
Test results on composite fabrics.

| | Composite | Composite |
|---|---|---|
| | Example 1 | Example 2 |
| Composite Testing | | |
| TPP after 5 laundering | >35 | >35 |
| THL (Total Heat Loss) | 197 | 221 |
| Flammability Testing | | |
| (ASTM D6413) | | |
| Char Length (inches) | 0.2 × 0.2 | <0.5 × <0.5 |
| After Flame (seconds) | 0.0 × 0.0 | 0.0 × 0.0 |
| No Melt No Drip | None | None |

### Examples 3, 4, 5

Table 3 lists single layer fabric Examples 3, 4, and 5 of preferred embodiments for technical rescue applications. Fabric 3 was a twill woven fabric at 6.8 oz/yd² (228 g/m²) comprised of 100% Tecgen® PPE fibers, which was used as baseline for comparison with fabric 4 and fabric 5. Fabric 4 at weight of 8.5 oz/yd² (285 g/m²) was identical to fabric 3, except that it was also laminated with a waterproof, breathable membrane. Fabric 5 at weight of 8.7 oz/yd² (291 g/m²) was identical to fabric 4, except that it was also coated with a sulfonated pentablock copolymer, known as Nexar™ MD9207 (KRATON, Houston, Tex. USA) in a mesh pattern on the surface of the ePTFE membrane.

TABLE 3
Examples of single layer fabrics for technical rescue.

| Fabric Example | Example 3 | Example 4 | Example 5 |
|---|---|---|---|
| Fabric Weight | 6.8 | 8.5 | 8.7 |
| (oz/yd²) | | | |
| Fiber | 100% Tecgen ® | 100% Tecgen ® | 100% Tecgen ® |
| Composition | PPE | PPE | PPE |
| Weave Style | Twill Weave | Twill Weave | Twill Weave |
| Construction | Fabric only | Fabric laminated | Fabric laminated |
| | | with breathable | with breathable |
| | | ePTFE membrane | ePTFE membrane |
| | | | and then mesh- |
| | | | coated with |
| | | | sulfonated |
| | | | pentablock |
| | | | copolymer |

Table 4 shows test results on single layer fabric Examples 3, 4, and 5. Fabric 4 and fabric 5 showed good flame resistance in the vertical flammability test in accordance with ASTM D6413. The testing results indicated that fabric having breathable ePTFE membrane laminated to the FR Tecgen® fabric did not have diminished performance on the vertical flammability of the fabrics. Similarly, sulfonated pentablock copolymer in mesh pattern coated on the surface of membranes of the laminated FR Tecgen® fabric did not have a negative impact on the vertical flammability of the laminated fabrics either.

TABLE 4
Test results on single layer fabric Examples 3, 4, and 5.

| Flammability Testing | Fabric | | |
|---|---|---|---|
| (ASTM D6413) | #3 | #4 | #5 |
| Char Length (inches), W × F | 0.4 × 0.4 | 0.3 × 0.3 | 0.3 × 0.2 |
| After Flame (Seconds), W × F | 0.0 × 0.0 | 0.0 × 0.0 | 0.0 × 0.0 |
| No Melt No Drip | None | None | None |

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±8%, or ±10%, of the numerical value(s) being modified. In addition, the phrase “about ‘x’ to ‘y’” includes “about ‘x’ to about ‘y’”.

### INDUSTRIAL APPLICABILITY

The systems and methods disclosed herein are applicable to the garment industry.

While the illustrative embodiments of the invention have been described with particularity, it will be understood that the invention is capable of other and different embodiments and that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present disclosure, including all features which would be treated as equivalents thereof by those skilled in the art to which the invention pertains.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A protective garment suitable for use as turnout gear comprising a two layer fabric construction of:
a) an outer layer of a flame resistant shell fabric laminated to a waterproof breathable layer; and
b) an inner layer of a thermal barrier comprising a nonwoven layer batted with a face cloth.

2. The garment of claim 1, wherein the flame resistant shell fabric is comprised of para-aramid fibers, meta-aramid fibers, polybenzoxazole fibers, polybenzimidazole fibers, melamine fibers, oxidized polyacrylonitrile fibers, partially oxidized polyacrylonitrile fibers, oxidized copolyacrylonitrile fibers, partially oxidized copolyacrylonitrile fibers, and combinations and blends thereof.

3. The garment of claim 1, wherein the waterproof breathable layer comprises a synthetic polymer membrane.

4. The garment of claim 3, wherein the synthetic polymer membrane is selected from the group consisting of expanded polytetrafluoroethylene, polyurethane, and microporous or hydrophobic material.

5. The garment of claim 1, further comprising a sulfonated copolymer coating, such as a sulfonated pentablock copolymer.

6. The coating of claim 5, said coating adhered to underside of the waterproof breathable layer.

7. The coating of claim 5, said coating adhered to the internally-facing side of the face cloth.

8. The coating of claim 5, wherein the sulfonated copolymer coating is a continuous coating.

9. The coating of claim 5, wherein the sulfonated copolymer coating is a discontinuous coating.

10. The garment of claim 1, wherein internal sewing seams of the outer layer are sealed by a flame resistant, waterproof adhesive tape.

11. A flame resistant garment comprising a one layer fabric construction, wherein the one layer has an outer flame resistant shell laminated to a waterproof, breathable membrane, and a thermal management polymer coating.

12. The garment of claim 11, wherein the outer flame resistant shell comprises fabric selected from the list consisting of para-aramid fibers, meta-aramid fibers, polybenzoxazole fibers, polybenzimidazole fibers, melamine fibers, oxidized polyacrylonitrile fibers, partially oxidized polyacrylonitrile fibers, oxidized copolyacrylonitrile fibers, partially oxidized copolyacrylonitrile fibers, and combinations and blends thereof.

13. The garment of claim 1, wherein the membrane comprises synthetic polymer membrane.

14. The garment of claim 11, wherein the waterproof, breathable membrane is selected from the group consisting of expanded polytetrafluoroethylene, polyurethane, microporous or hydrophobic materials.

15. The garment of claim 11, wherein the thermal management polymer coating comprises sulfonated copolymer in a continuous coating.

16. The garment of claim 11, wherein the thermal management polymer coating comprises sulfonated copolymer in a discontinuous coating.

17. The garment of claim 15, wherein said sulfonated copolymer is a sulfonated pentablock copolymer.

18. The garment of claim 11, wherein said coating is adhered to an underside of the membrane.

19. The garment of claim 11, wherein internal sewing seams of the outer flame resistant shell are sealed by a flame resistant, waterproof adhesive tape.
